(19) United States
(12) Patent Application Publication
(10) Pub. No.: US 2009/0292780 A1
(43) Pub. Date: Nov. 26, 2009

(54) SYSTEM AND METHOD FOR SELECTIVE APPLICATION OF A FEATURE TO MULTIPLE RECIPIENTS OF AN EMAIL MESSAGE

(76) Inventors: Rajaram Ramesh, Raleigh, NC (US); Kumar Balachandran, Cary, NC (US); Havish Koorapaty, Cary, NC (US)

Correspondence Address: ERICSSON INC., 6300 LEGACY DRIVE, M/S EVR 1-C-11, PLANO, TX, 75024, US

(21) Appl. No.: 12/125,472

(22) Filed: May 22, 2008

(51) Int. Cl. G06F 15/16

(52) U.S. Cl. 709/206

(57) ABSTRACT

A system and method of selectively utilizing a feature with an email message. The method includes processing, by a mail client within a user's computer, a single email message for a plurality of recipients. The mail client receives a designated first set of recipients of the plurality of recipients for receiving the email message with a specific feature and a designated second set of recipients of the plurality of recipients for receiving the email message without the specific feature. In addition, a copy of the email message is generated without the specific feature. The email message is then sent with the specified feature to the first set of recipients and a copy of the email message without the specified feature is sent to the second set of recipients. The specific feature may be an attachment, an encryption of the message, or any other feature associated with the email message. In another embodiment, an extension header may be applied to the header of the email message to distinguish the first set of recipients from the second set of recipients. The message may then be sent to an email server which reformats the message into two messages according to the header extensions.

### BACKGROUND OF THE INVENTION

The present invention relates to communications networks. More particularly, and not by way of limitation, the present invention is directed to a system and method for applying a specified feature to a plurality of recipients of an email message.

A wide variety of email programs are used by subscribers worldwide. Almost all of these mail programs include the ability to attach files to messages. These attachments can be large and may consume significant storage space at both the mail servers and the local hosts. The mail programs also allow such email messages to be “broadcast” to many recipients.

However, there are many situations in which the recipients of a broadcast email do not need to receive the attachment files. For example, an individual prepares an email message with an attached document for a client, but desires to inform the individual's supervisor that the document has been sent. However, the supervisor may not need to receive a copy of the document, but rather just the email message without the attached document. Currently, the individual can send an email with the attachment to the client and the supervisor. The supervisor may then retain the email while deleting the attachment to prevent unnecessary storage of the document. Alternatively, the individual can send two separate emails, one email to the client with the attachment and one separate email to the supervisor without the attachment. Obviously, using this procedure may increase the workload on the individual unnecessarily.

Similar problems are seen with other features associated with emails, such as privacy and encryption features. For example, recipients within a corporate network may not necessarily have to encrypt a particular message, but such encryption may be necessary for external recipients of the same message. However, current existing email systems do not allow differentiating such features for different recipients in a single email message.

### BRIEF SUMMARY OF THE INVENTION

The present invention provides a system and method for sending multiple email messages to a plurality of recipients having different features. Thus, in one aspect, the present invention is directed to a method of selectively utilizing a feature with an email message. The method includes processing, by a mail client within a user's computer, a single email message for a plurality of recipients. The mail client receives a designated first set of recipients of the plurality of recipients for receiving the email message with a specific feature and a designated second set of recipients of the plurality of recipients for receiving the email message without the specific feature. In addition, a copy of the email message is generated without the specific feature. The email message is then sent with the specified feature to the first set of recipients and a copy of the email message without the specified feature is sent to the second set of recipients. The copy of the email may contain an indication of the presence of the specific feature that was not included in the copy. The specific feature may be an attachment, an encryption of the message, or any other feature associated with the email message.

In another aspect, the present invention is directed to a system for selectively utilizing a feature with an email message. The system includes a mail client stored within a user's computer. The user inputs a plurality of recipients into a single email message. The user, through the mail client, designates a first set of recipients of the plurality of recipients for receiving the email message with a specific feature and a second set of recipients of the plurality of recipients for receiving the email message without the specific feature. The mail client, responsive to determining that a second set of recipients is designated, then adds a copy of the email message without the specific feature. The system also includes an email server for sending the email message with the specified feature to the first set of recipients and sending the copy of the email message without the specified feature to the second set of recipients.

In yet another aspect, the present invention is directed to a mail client for selectively utilizing a feature with an email message. The mail client allows a user to input a plurality of recipients into a single email message and designate a first set of recipients of the plurality of recipients for receiving the email message with a specific feature and a second set of recipients of the plurality of recipients for receiving the email message without the specific feature. The mail client, responsive to determining that a second set of recipients is designated, adds a copy of the email message without the specific feature.

In another aspect, the present invention is directed to a method of selectively utilizing a feature with an email message. The method includes the steps of providing a mail client within a user's computer, providing the mail client a single email message to a plurality of recipients, designating a first set of recipients of the plurality of recipients for receiving the email message with a specific feature and a second set of recipients of the plurality of recipients for receiving the email message without the specific feature, and sending the email message with the designated first set of recipients and the second set of recipients to an email server. Responsive to receiving the second set of recipients, the email server reformats the email message into a first email message with the specific feature and a second email message without the specific feature. The first and second email messages are then sent to the respective recipients.

In still another aspect, the present invention is an email server for selectively utilizing a feature with an email message. The email server, responsive to receiving a first set of recipients of a plurality of addresses for the email message for receiving the email message with a specific feature and a second set of recipients of the plurality of addresses for receiving the email message without the specific feature, reformats a received email message into a first email message with a specific feature and a second email message without the specific feature. The email server then sends the first email message to the first set of recipients and the second email message to the second set of recipients.

### BRIEF DESCRIPTION OF THE SEVERAL VIEWS OF THE DRAWING

In the following section, the invention will be described with reference to exemplary embodiments illustrated in the figures, in which:

FIG. 1 illustrates a high level block diagram of an email system in accordance with an embodiment of the present invention;

FIG. 2 is a flowchart illustrating the steps for selectively appending attachments to email messages in accordance with an embodiment of the present invention;

FIG. 3 is a flowchart illustrating the steps for selectively utilizing a feature with email messages in accordance with an embodiment of the present invention;

FIG. 4 is a high level block diagram of the email server in accordance with an embodiment of the present invention;

FIG. 5 is a flowchart illustrating the steps for selectively appending attachments to email messages in accordance with an embodiment of the present invention; and

FIG. 6 is a flowchart illustrating the steps for selectively utilizing a specified feature in email messages in accordance with an embodiment of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

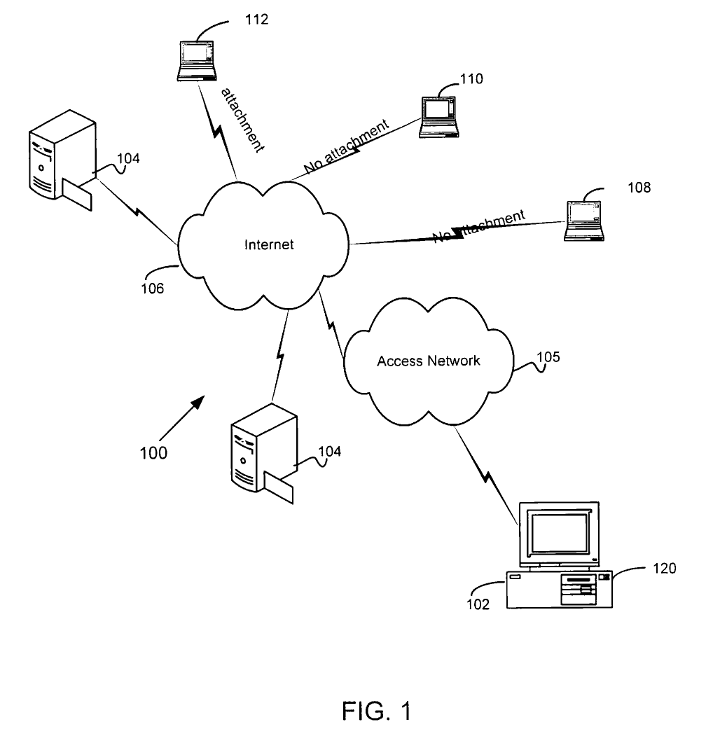

FIG. 1 illustrates a high level block diagram of an email system 100 in accordance with an embodiment of the present invention. A mail client 120 is installed on a computer 102. The computer 102 is connected to the Internet 106 via an Access Network 105, further allowing connectivity to an email server 104. While the email Server is shown as connected to the Internet, it will be readily apparent that there is no loss of generality that prevents such connection to occur through another Access Network Provider, a Virtual Private Network (VPN), or for such connection to occur completely within the user's access network 105. The computer may be any device providing communication with the Internet, such as a computer, mobile station or personal data assistant. Although the Internet is depicted, the present invention may be utilized in any network environment. The email server preferably is capable of identifying and addressing emails to recipients with attachments. Typically, an attachment may be attached to an email message and sent to a specific recipient or recipients. Generally, in most email programs, an icon is utilized to attach a specific document to the email message. In addition, the email program provides an address area for specifying the recipient or recipients of the email. The email message, including the attached document, is then sent to the recipients listed in the address area of the email program.

However, in the present invention, the email message may be sent to one of several recipients, where one or more of the recipients receive the email message with the attachment and one or more of the recipients receive the email message without the attachment. As depicted in FIG. 1, recipients 108 and 110 receive the email message with the attachment, while recipient 112 receives the email message without an attachment. The recipients receive the email message through a device capable of communicating with the Internet, such as a computer, mobile station, personal data assistant, etc.

In one embodiment, the mail client 120 creates two separate email messages. A user initiates the mail client 120 in the computer 102. The user addresses the email message to one or more addressees. In addition, the user, through the mail client, designates each address (recipient) which receives the email message with an attachment and which address receives the email message without an attachment. For example, the user may designate recipients 108 and 110 as receiving the email message with the attachment (e.g., a first set of recipient or recipients) while the user designates that the email message addressed for recipient 112 (e.g., a second set of recipient or recipients) is sent without the attachment. Preferably, the mail client 120 provides a graphical user interface (GUI) to selectively provide those addressees which are to receive the attachment with the email. For example, the mail client may provide an icon or menu to the user for the selection of sending the attachment. It should be understood that the user may designate the recipients that receive the email message with the attachment and/or the recipients receiving the email message without the attachment. The user then directs the email message to be sent. The mail client processes the email message and determines if there are recipients that receive the email message without the attachment. If there are recipients that are designated as receiving the email message without an attachment, the mail client creates two separate messages. In the first email message, the email message includes the attachment. In the second email message, the email message does not include the attachment. Optionally, the second message may also include an indicator within the email message that the message was sent with an attachment to other recipients (e.g., recipients 108 and 110). Each message is preferably delivered to a primary address set that is mutually exclusive from the corresponding set in the other message. It is an optional feature of the present invention to indicate the secondary addresses (e.g., those not in the primary set) using a header field, e.g., “other recipients,” that is not processed by the mail server or mail transfer agent in the network. Both messages include the names of all the recipients. However, the mail client modifies the mail protocol to send the two messages to the two sets of recipients. The two email messages, one email message with the attachment and the other email message without the attachment, are then sent to an email server 104 for processing. When the mail client processes the email message, if the user does not designate that a recipient is to be sent to an email message without an attachment, the email message is sent to the email server 104 and processed normally.

In this embodiment, the method may optionally be extended for the user of blind carbon copies of messages, where a set of recipients may not see another set of recipients. The user may indicate which of the blind carbon copy recipients need to receive the attachments. An extension of the implementation is to create a special category where carbon-copies alone are created without attachments included, while all primary recipients receive attachments included with the message.

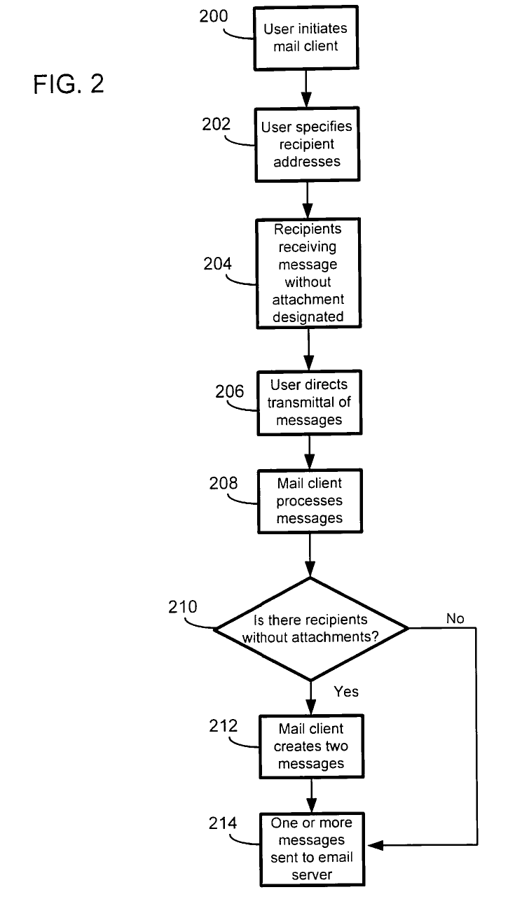

FIG. 2 is a flowchart illustrating the steps for selectively appending attachments to email messages in accordance with an embodiment of the present invention. With reference to FIGS. 1 and 2, the method will now be explained. In step 200, a user initiates the mail client 120 in computer 102. Next, in step 202, the user inputs email addresses for the message. In step 204, the user designates the recipients that are to receive the attachment and the recipients that are not to receive the attachment. For example, the user may select recipient 108 and 110 as receiving the email message with the attachment while the user designates that the email addressed for recipient 112 does not include an attachment. Preferably, the mail client 120 provides a GUI to selectively provide those addressees which are to receive the attachment with the email, such as an icon or menu for the selection of sending the attachment. In step 206, the user then directs that the email message be sent. In step 208, the mail client processes the email message. Next, in step 210, the mail client determines if there are recipients that do not receive the attachment with the email message. If it is determined there are recipients designated as receiving the email message without an attachment, the mail client creates two separate messages in step 212. The first message includes the attachment. The second message does not include the attachment. Optionally, the second message also includes an indicator that the email message was sent with an attachment. Both messages include the names of all the recipients. In addition, the mail client modifies the mail protocol to send the two messages to the two sets of recipients. In step 214, the two email messages, one with the attachment and the other without the attachment, are then sent to an email server.

However, in step 210, if the mail client determines that there are no recipients for which the user desires that the email message be sent without an attachment, the mail client processes the email message normally and sends the email message to the email server for processing in step 214.

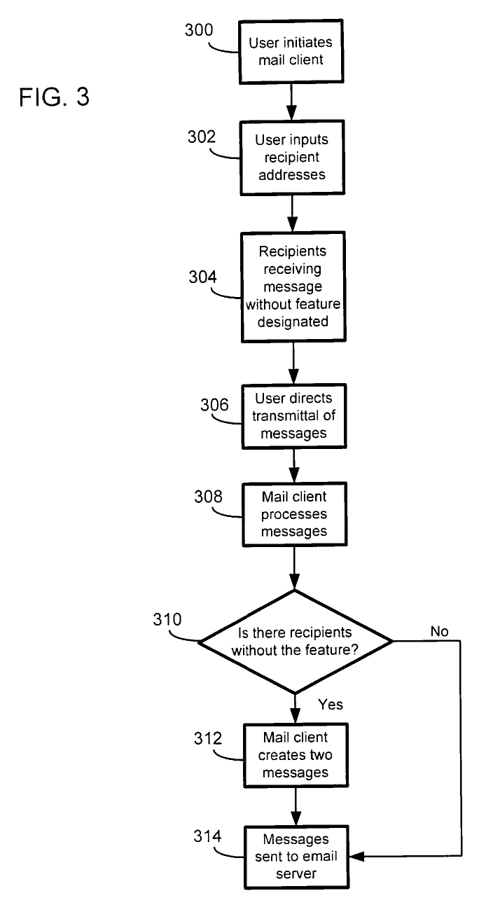

The present invention may be applied in processing email messages utilizing other features other than sending attachments. For example, there may be a need to encrypt a message to certain recipients, such as those outside a corporate network. In another example, there may be a need to utilize a feature which adds extension headers, such as those defined in RFC 132 (e.g., “Importance” and “Sensitivity”). Specific recipients may need to indicate sensitivity (e.g., company confidential) for recipients external to a corporation while internal messages do not require such headers. FIG. 3 is a flowchart illustrating the steps for selectively utilizing a feature with email messages in accordance with an embodiment of the present invention. The feature may be anything utilized in an email message, such as encryption. With reference to FIGS. 1 and 3, the method will now be explained. In step 300, a user initiates the mail client 120 in computer 102. Next, in step 302, the user inputs email addresses for the message. In step 304, the user designates the recipients that utilize a specified feature and the recipients that are not utilizing the feature. For example, the user may select recipients 108 and 110 as receiving the email message with the feature, while the user indicates that the email addressed for recipient 112 does not use the feature. Preferably, the mail client 120 provides a GUI for selectively providing those addressees which are to utilize the feature with the email, such as an icon or menu for the selection of sending email message with the feature. It should be understood that the user may designate the recipients that receive the email message with the feature and/or the recipients receiving the email message without the feature. In step 306, the user then directs that the email message be sent. In step 308, the mail client processes the email message. Next, in step 310, the mail client determines if there are recipients that do not utilize the specified feature with the email message. If it is determined there are recipients that the user does not desire to send the email message with the specified feature, the mail client creates two separate messages in step 312. In the first message, the message includes the feature. In the second message, the message does not include the feature. Optionally, the second message also includes an indicator that the email message was sent with the specified feature. Both messages include the names of all the recipients. However, the mail client modifies the mail protocol to send the two messages to the two sets of recipients. In step 314, the two email messages, one with the feature and the other without the feature, are then sent to an email server. This method is particularly applicable for the use of encryption to multiple recipients. For example, addressees outside of a corporate network may receive encrypted versions of the message to prevent eavesdropping, while addressees within a trusted network may not need encryption. It is to be noted that encryption being a procedure that is usually done at the client, cannot be selectively applied in a manner that allows expression of that feature in a second embodiment of the invention to be discussed below.

However, in step 310, if the mail client determines that there are no recipients for which the user desires that the email message be sent without the specified feature, the mail client processes the email message in a normal fashion and sends the email message to the email server for processing in step 314.

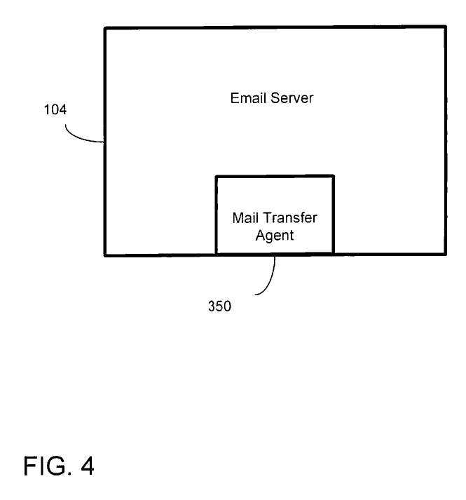

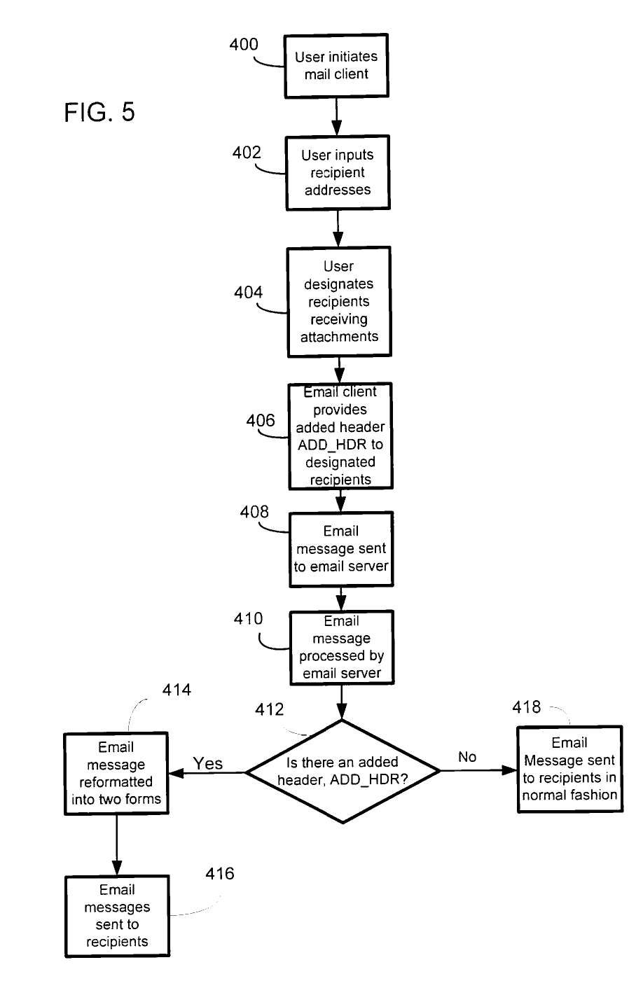

FIG. 4 is a high level block diagram of the email server 104 in accordance with an alternative embodiment of the present invention. The email server includes a Mail Transfer Agent 350. In another embodiment of the present invention, an extension may be added to a standard header format. In this embodiment, a user initiates the mail client 120 in the computer 102. The user inputs one or more email addresses for the message. In addition, the user, through the mail client, designates each address which receives an attachment and/or which address does not receive an attachment. For example, the user may designate the addresses of recipients 108 and 110 as receiving the email message with the attachment, while the user designates that the email addressed for recipient 112 does not include an attachment. The user then sends the email message with the attachment. In this embodiment, the email server sends messages with attachments to the designated recipients, according to a particular header modification. A special header provided by the mail client on the user's computer enables the email server to strip the attachment from designated email messages before forwarding to the recipient's address. An example of a header format utilizing such an extension is as follows:
From: sender@myaddress.com
To: recipient_{—}1address1.com, . . . recipient N@addressN.com
Attachments-not-intended-for: recipient_{—}1address1.com, recipient_i2@address 2.com
   where indices i1, i2, etc., are one or more indices drawn from the set 1, 2, . . . ,N designating the N recipients of the message. Moreover, it is clear that the “Attachments-not-intended-for:” header format corresponds to the added header ADD_HDR in FIG. 5.

The Mail Transfer Agent 350 at the email server, interprets the added header and reformats the message into two forms, one email message unaltered with the attachment, and the other email message modified such that all attachments that were not encapsulated using the text/plain or text/<sub-type> MIME-format are removed and an optional indication such as <Removed attachment_x of type y> is inserted.

FIG. 5 is a flowchart illustrating the steps for selectively appending attachments to email messages in accordance with an embodiment of the present invention. With reference to FIGS. 1, 4, and 5, the method will now be explained. In step 400, a user initiates the mail client 120 in the computer 102. Next, in step 402, the user inputs email addresses for the message. In step 404, the user designates the recipients that are to receive the attachment and the recipients that are not to receive the attachment. The user may also optionally activate an indicator to the recipients designated for receipt of only the message without the attachment. In step 406, the email client provides a special header designating email messages before forwarding to the recipient's address. An example of a header format utilizing such an extension is as follows:
From: sender@myaddress.com
To: recipient_1@address1.com, . . . recipient N@addressN.com
Attachments-not-intended-for: recipient_i1@address1.com, recipient_i2@address 2.com
   where indices i1, i2, etc., are one or more indices drawn from the set 1, 2, . . . ,N designating the N recipients of the message. Moreover, it is clear that the “Attachments-not-intended-for:” header format corresponds to the added header ADD_HDR in FIG. 5.

In step 408, the user sends the email message with the attachment to email server. Next, in step 410, the email server processes the email message. In step 412, it is determined by the email server if an extension is added to the header of the email message. If it is determined that a header extension has been added, in step 414, the Mail Transfer Agent 350 reformats the email message into two forms, one unaltered and the other modified such that all attachments that were not encapsulated using the using the text/plain MIME-format are removed and an optional indication such as <Removed attachment_x of type y> is inserted. Next, in step 416, the altered and unaltered email messages are sent to the designated recipients. However, in step 412, if the email server determines that an extension has not been added, the email server sends the email message in a normal fashion to the designated recipients in step 418.

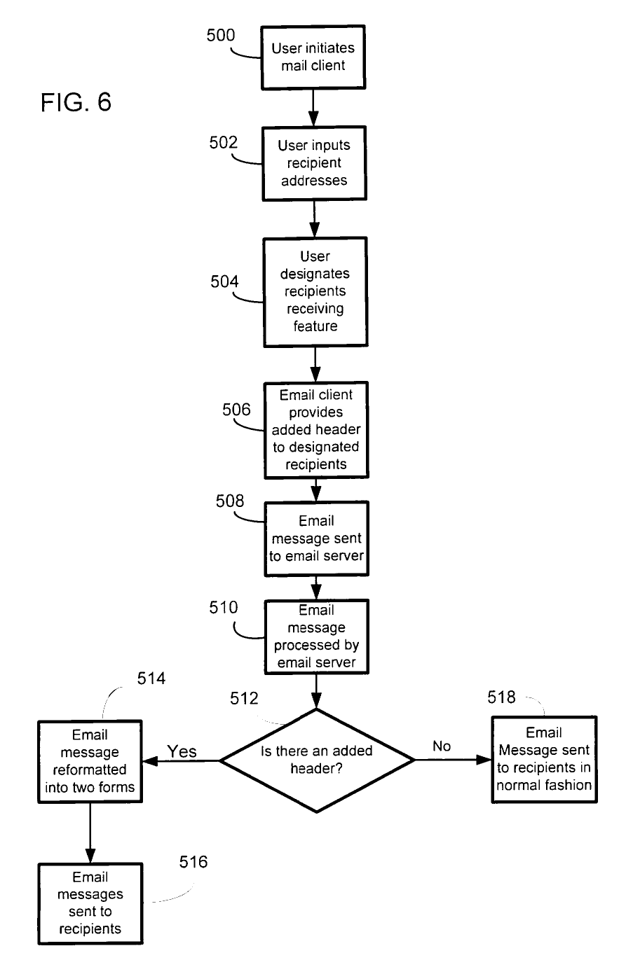

The present invention may be utilized in processing email messages utilizing other features other than sending attachments. For example, there may be a need to encrypt a message to certain recipients, such as outside a corporate network. In another example, there may be a need to utilize a feature which adds extension headers, such as those defined in RFC 132 (e.g., “Importance” and “Sensitivity”). Specific recipients may need to indicate sensitivity (e.g., company confidential) for recipients external to a corporation while internal messages do not require such headers. FIG. 6 is a flowchart illustrating the steps for selectively utilizing a specified feature in email messages in accordance with an embodiment of the present invention. With reference to FIGS. 1, 4, and 6, the method will now be explained. In step 500, a user initiates the mail client 120 in the computer 102. Next, in step 502, the user inputs the email addresses for the message. In step 504, the user designates the recipients that are to receive the email message with the specified feature and the recipients that are not to receive email message without the feature. The user may also optionally activate an indicator to the recipients designated for receipt of only the message without the feature. In step 506, the email client provides a special header designating email messages before forwarding to the recipient's address. An example of a header format utilizing such an extension is as follows:
From: sender@myaddress.com
To: recipient_{—}1(address1.com, . . . recipient N@addressN.com
Feature-not-intended-for: recipient_i1@address1.com, recipient_i2@address 2.com
   where indices i1, i2, etc., are one or more indices drawn from the set 1, 2, . . . ,N designating the N recipients of the message. Moreover, it is clear that the “Attachments-not-intended-for:” header format corresponds to the added header ADD_HDR in FIG. 5.

In step 508, the user sends the email message with the feature to the email server. Next, in step 510, the email server processes the email message. In step 512, it is determined by the email server if an extension is added to the header of the email message. If it is determined that a header extension has been added, in step 514, the Mail Transfer Agent 350 reformats the email message into two forms, one unaltered and the other modified such that the feature is removed and provided with an optional indicator of the removal of the feature. Next, in step 516, the altered and unaltered email messages are sent to the designated recipients. However, in step 512, if the email server determines that an extension has not added, the email server sends the email message to the designated recipients in step 518 in a normal fashion.

It should be understood that the present invention may be utilized to provide any specified features to an email message sent to a plurality of recipients. In addition, the designation of the recipients for transmittal of the email message with and without the feature may be provided in any fashion and still remain in the scope of the present invention. For example, the user may designate those recipients utilizing the feature while all other non-designated recipients are automatically sent the email message without the feature. Alternatively, the user may designate those recipients not utilizing the feature while all the other recipients are automatically sent the email message with the feature. The present invention provides an email system and method enabling a user to send one email message to a plurality of recipients while simultaneously designated which recipients are sent a specified feature with the email message.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of selectively utilizing a feature with an email message, the method comprising the steps of:
processing, by a mail client within a user's computer, a single email message for a plurality of recipients, the mail client receiving a designated first set of recipients of the plurality of recipients for receiving the email message with a specific feature and a designated second set of recipients of the plurality of recipients for receiving the email message without the specific feature;
generating, by the mail client, a copy of the email message without the specific feature;
sending, by the mail client, the email message with the specified feature to the first set of recipients; and
sending, by the mail client, the copy of the email message without the specified feature to the second set of recipients.

2. The method as recited in claim 1 wherein the specific feature is an attachment to the email message.

3. The method as recited in claim 1 wherein the copy of the email message addressed in the first set of recipients includes information about the second set of recipients.

4. The method as recited in claim 3 wherein the copy of the email message sent to the second set of recipients includes an indicator that the email message sent to the first set of recipients includes the specified feature.

5. The method as recited in claim 1 wherein the copy of the message addressed in the second set of recipients includes information about the first set of recipients.

6. The method as recited in claim 1 wherein the step of generating a copy of the email message without the specific feature includes modifying a mail protocol header of the copy of the email message.

7. The method as recited in claim 1 wherein the specific feature is an encryption of the email message.

8. The method as recited in claim 1 wherein the specific feature is an extension header providing a sensitivity level of the email message.

9. The method as recited in claim 1 wherein the step of processing a single email message includes designating the second set of recipients and any remaining addresses being automatically designated as the first set of recipients.

10. A system for selectively utilizing a feature with an email message, the system comprising:
a mail client stored within a user's computer, the mail client providing a means for inputting a plurality of recipients into a single email message;
means within the mail client for designating a first set of recipients of the plurality of recipients for receiving the email message with a specific feature and a second set of recipients of the plurality of recipients for receiving the email message without the specific feature,
wherein the mail client, responsive to determining that a second set of recipients is designated, includes means for generating a copy of the email message without the specific feature; and
an email server for sending the email message with the specified feature to the first set of recipients and sending the copy of the email message without the specified feature to the second set of recipients.

11. The system as recited in claim 10 wherein the specific feature is an attachment to the email message.

12. The system as recited in claim 10 wherein the second set of recipients is provided a copy of the email message with an indicator that the email message sent to the first set of recipients includes the specified feature.

13. The system as recited in claim 10 wherein the mail client includes means for modifying a mail protocol header of the copy of the email message.

14. The system as recited in claim 10 wherein the email message with the specific feature and the copy of the email message without the specific feature include an indicator of the first set and the second set of recipients.

15. The system as recited in claim 10 wherein the copy of the email message addressed in the first set of recipients includes information about the second set of recipients.

16. The method as recited in claim 10 wherein the copy of the message addressed in the second set of recipients includes information about the first set of recipients.

17. The system as recited in claim 10 wherein the specific feature is an encryption of the email message.

18. The system as recited in claim 10 wherein the specific feature is an extension header providing a sensitivity level of the email message.

19. The system as recited in claim 10 wherein the means for processing a single email message includes designating the second set of recipients and any remaining recipients are automatically designated as the first set of recipients.

20. An email client for selectively utilizing a feature with an email message, the mail client comprising:
means for inputting a plurality of recipients into a single email message; and
means for designating a first set of recipients of the plurality of recipients for receiving the email message with a specific feature and a second set of recipients of the plurality of recipients for receiving the email message without the specific feature;
means for generating a copy of the email message without the specific feature, the means for generating a copy of the email message responsive to the second set of recipients being designated.

21. A method of selectively utilizing a feature with an email message, the method comprising the steps of:
processing, by a mail client within a user's computer, a single email message for a plurality of recipients, the mail client receiving a designated first set of recipients of the plurality of recipients for receiving the email message with a specific feature and a designated second set of recipients of the plurality of recipients for receiving the email message without the specific feature;
sending the email message with the designated first set of recipients and the second set of recipients to an email server;
responsive to receiving the second set of recipients, reformatting, by the email server, the email message into a first email message with the specific feature and a second email message without the specific feature; and
sending the first email message to the first set of recipients and the second email message to the second set of recipients.

22. The method as recited in claim 21 further comprising after designating a first set of recipients and a second set of recipients, the step of adding an extension to a standard header of the email message indicating the first set of recipients and the second set of recipients.

23. The method as recited in claim 22 wherein the step of reformatting the email message includes the email server interpreting the added header to distinguish the first set of recipients from the second set of recipients.

24. The method as recited in claim 21 wherein the specific feature is an attachment to the email message.

25. The method as recited in claim 21 wherein the second set of recipients is provided a copy of the email message with an indicator that the email message sent to the first set of recipients includes the specified feature.

26. The method as recited in claim 21 wherein the specific feature is an encryption of the email message.

27. The method as recited in claim 21 wherein the specific feature is an extension header providing a sensitivity level of the email message.

28. The method as recited in claim 21 wherein the step of designating a first set and a second set of recipients includes designating the second set of recipients and any remaining recipients being automatically designated as the first set of recipients.

29. A system for selectively utilizing a feature with an email message, the system comprising:
a mail client stored within a user's computer, the mail client providing a means for inputting a plurality of recipients into a single email message:
means within the mail client for designating a first set of recipients of the plurality of recipients for receiving the email message with a specific feature and a second set of recipients of the plurality of recipients for receiving the email message without the specific feature;
means within the mail client for sending the email message with the designated first set of recipients and the second set of recipients to an email server;
an email server, responsive to receiving the second set of recipients, for reformatting the email message into a first email message with the specific feature and a second email message without the specific feature,
means within the email server for sending the first email message to the first set of recipients and the second email message to the second set of recipients.

30. The system as recited in claim 29 wherein the means for designating a first set of recipients and a second set of recipients includes adding an extension to a standard header of the email message indicating the first set of recipients and the second set of recipients.

31. The system as recited in claim 29 wherein the email server interprets the added header to distinguish the first set of recipients from the second set of recipients.

32. The system as recited in claim 29 wherein the specific feature is an attachment to the email message.

33. The system as recited in claim 29 wherein the second set of recipients is provided a copy of the email message with an indicator that the email message sent to the first set of recipients includes the specified feature.

34. The system as recited in claim 29 wherein the specific feature is an encryption of the email message.

35. The system as recited in claim 29 wherein the specific feature is an extension header providing a sensitivity level of the email message.

36. An email server for selectively utilizing a feature with an email message, the email server comprising:
responsive to receiving a first set of recipients of a plurality of addresses for the email message for receiving the email message with a specific feature and a second set of recipients of the plurality of addresses for receiving the email message without the specific feature, means for reformatting a received email message into a first email message with a specific feature and a second email message without the specific feature; and
means within the email server for sending the first email message to the first set of recipients and the second email message to the second set of recipients.

37. The email server as recited in claim 36 wherein the email server interprets an added header to the email message to distinguish the first set of recipients from the second set of recipients.
